(19) United States
(12) Patent Application Publication
(10) Pub. No.: US 2015/0087321 A1
(43) Pub. Date: Mar. 26, 2015

(54) METHODS AND SYSTEMS FOR SMALL CELLS DEPLOYMENT

(71) Applicant: WeFi Inc., Marlborough, MA (US)

(72) Inventor: Shimon Scherzer, Korazim (IL)

(73) Assignee: WeFi Inc., Marlborough, MA (US)

(21) Appl. No.: 14/494,113

(22) Filed: Sep. 23, 2014

Related U.S. Application Data
(60) Provisional application No. 61/881,019, filed on Sep. 23, 2013.

(51) Int. Cl. H04W 16/18

(52) U.S. Cl. CPC H04W 16/18
USPC 455/446

(57) ABSTRACT

Methods and systems for small cells deployment are disclosed. A small cells deployment system may collect user activity data associated with each of a plurality of sections within an area of interest; determine a first set of activity metrics based on the user activity data, the first set of activity metrics including a first activity metric associated with each of the plurality of sections; determine a second set of activity metrics for the plurality of sections by applying a filter to the first set of activity metrics, the second set of activity metrics including a second activity metric associated with each of the plurality of sections; select one or more sections based on the second set of activity metrics; and identify one or more locations for small cells deployment within or around the one or more sections.

### RELATED APPLICATIONS

The present application claims the benefit of U.S. Provisional Application No. 61/881,019, filed Sep. 23, 2013, which is incorporated herein by reference.

### TECHNICAL FIELD

The present disclosure relates to the field of wireless network and, more particularly, methods and systems for small cells deployment.

### BACKGROUND

Small cells, such as cellular and WiFi access points that are characterized by low transmission power and small antennas, are increasingly being used for wireless traffic. The coverage of small cells is usually very small compared with typical macro cells deployment. Consequently, deployment of small cells requires high precision such that the small cells are deployed in a place with high user traffic and low traffic speed so as to enhance the user experiences.

Operators often user performance reports generated by mobile devices to characterize wireless activity in given areas, and to determine optimal locations for additional small cells deployment. In many cases, however, only a small fraction of mobile devices in an area is participating in the reporting process. As a result, the information of wireless activity gathered by the operators is thin and may not represent the typical wireless activity in the area.

Improvements in planning small cells deployment that allow pin-pointing small cells deployment locations with limited number of reporting devices are desirable.

### SUMMARY

In one disclosed embodiment, a method for small cells deployment in a network is disclosed. The method comprises collecting user activity data associated with each of a plurality of sections within an area of interest; determining a first set of activity metrics based on the user activity data, the first set of activity metrics including a first activity metric associated with each of the plurality of sections; determining a second set of activity metrics for the plurality of sections by applying a filter to the first set of activity metrics, the second set of activity metrics including a second activity metric associated with each of the plurality of sections; selecting one or more sections based on the second set of activity metrics; and identifying one or more locations for small cells deployment within or around the one or more sections.

In another disclosed embodiment, a small cells deployment system is disclosed. The small cells deployment system comprises at least one processor and at least one memory device. The at least one memory device comprises instructions which, when executed by the at least one processor, cause the small cells deployment system to perform operations including: collecting user activity data associated with each of a plurality of sections within an area of interest; determining a first set of activity metrics based on the user activity data, the first set of activity metrics including a first activity metric associated with each of the plurality of sections; determining a second set of activity metrics for the plurality of sections by applying a filter to the first set of activity metrics, the second set of activity metrics including a second activity metric associated with each of the plurality of sections; selecting one or more sections based on the second set of activity metrics; and identifying one or more locations for small cells deployment within or around the one or more sections.

Additional aspects related to the embodiments will be set forth in part in the description which follows, and in part will be obvious from the description, or may be learned by practice of the invention. For example, a network architecture or organization can be improved using the disclosed deployment method and system.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an example geographical region with a network architecture, in accordance with some of the disclosed embodiments.

FIG. 2 illustrates an example system that may be used for implementing the disclosed embodiments.

FIG. 3 illustrates an example device that may be used for implementing the disclosed embodiments.

FIG. 4 illustrates an example method for planning small cells deployment, in accordance with some of the disclosed embodiments.

FIG. 5 illustrates an example map for constructing a smoothing filter for planning small cells deployment in accordance with some of the disclosed embodiments.

FIG. 6 illustrates an example map for selection of small cells deployment sections in accordance with some of the disclosed embodiments.

FIG. 7 illustrates an example map for identifying small cells deployment locations in accordance with some of the disclosed embodiments.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Systems, methods, and computer-readable media are described that identify potential locations for small cells deployment. In the present disclosure, small cells include both cellular and WiFi access points that are characterized by low transmission power and small antennas. For example, systems, methods, and computer-readable media are described in which an area of interest for potential small cells deployment is divided into a number of sections. The small cells deployment planning system may collect user activity data such as amount of cell traffic, speed of cell traffic, in each of the sections over a pre-defined time period. The small cells deployment planning system may calculate an activity metric value for each of the sections. A smoothing filter may be applied to the activity metrics values to improve accuracy of the calculated activity metrics. The small cells deployment planning system may select one or more sections with the highest activity metrics values, and identify locations within or around the selected sections for small cells deployment.

U.S. Pat. No. 8,000,276 describes systems and methods for enhancing connectivity to radio access points, U.S. Pat. No. 8,358,638 describes system and method for the establishment and maintenance of wireless network, U.S. Pat. Nos. 8,750,265 and 8,477,645 describe systems and methods of automatically connecting a mobile communication device to a network using a communications resource database, the contents of all of which are incorporated herein by reference.

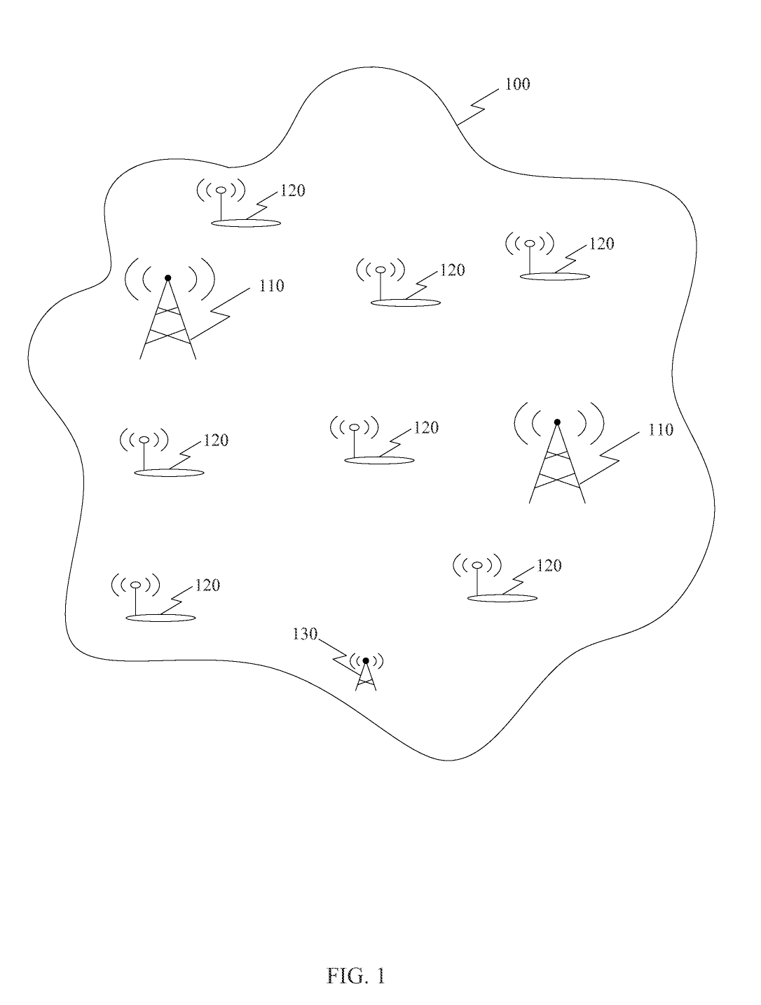

FIG. 1 is a diagram illustrating an example geographic region 100 according to some disclosed embodiments. Geographic region 100 may be, for example, an area within a city, state, or country, or any other geographical area. In some embodiments, geographical region 100 comprises a number of transceivers 110 configured to manage communications in a cellular network protocol, a number of transceivers 120 configured to manage communications in a WLAN network protocol, and a number of other transceivers, such as, for example, transceivers 130 configured to manage communications in a small cell network. In some embodiments, the area serviced (i.e., the area provided wireless network coverage) by one or more cellular networks' transceivers 110, one or more WLAN networks' transceivers 120, and/or one or more other transceivers, can overlap. For example, a cellular transceiver 110 may provide cellular network coverage for a first area and a WLAN transceiver 120 may provide WLAN network coverage for a second area that at least partially overlaps the first area.

Each of the one or more cellular transceivers 110 may be operated by the same communications service providers (CSP) or different CSPs. Similarly, each of the WLAN transceivers 120 may be operated by the same CSP or different CSPs. And each of the small cell network transceivers 130 may be operated by the same CSP or different CSPs. Thus, for example, a first small cell network transceiver 130 operated by a first CSP and a second small cell network transceiver 130 operated by a second CSP may provide network coverage for areas that at least partially overlap. While FIG. 1 depicts a specific number of cellular transceivers 110, WLAN transceivers 120, and small cell network transceivers 130, in some embodiments geographical region 100 includes any number of cellular transceivers 110, WLAN transceivers 120, and small cell network transceivers 130, including no cellular transceivers 110, WLAN transceivers 120, or small cell network transceivers 130.

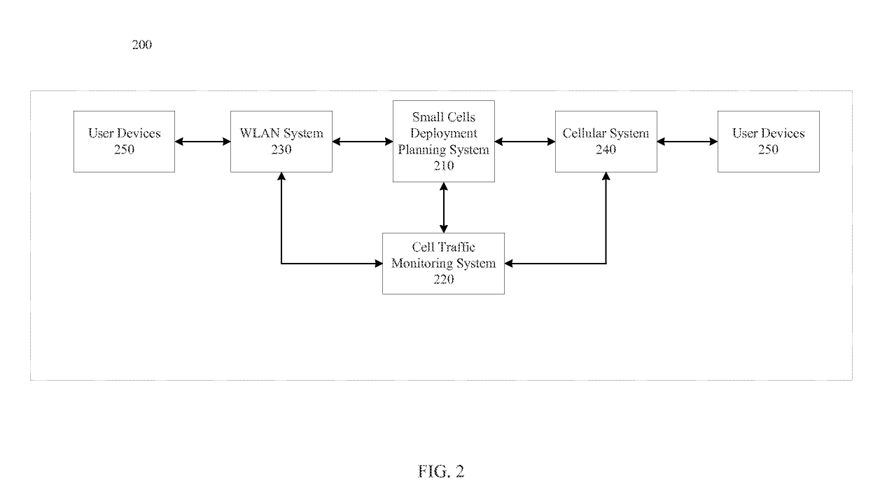

FIG. 2 is a diagram illustrating an example system 200 that may be used to implement the disclosed embodiments. In some embodiments, system 200 includes one or more Small Cells Deployment Planning Systems 210, one or more Cell Traffic Monitoring Systems 220, one or more WLAN Systems 230, one or more Cellular Systems 240, and one or more User Devices 250.

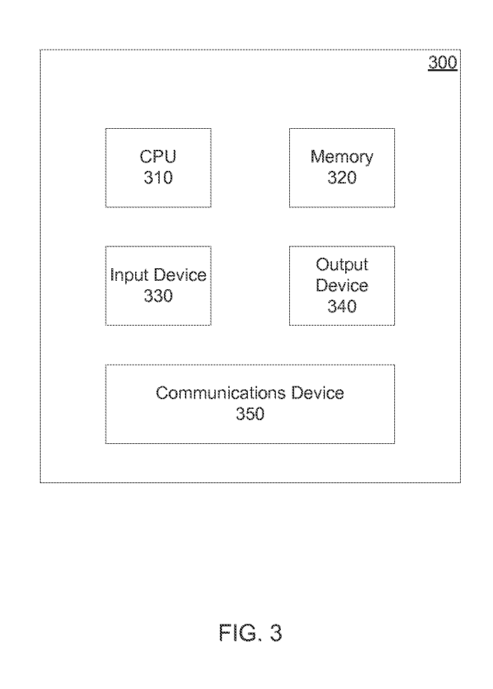

Small Cells Deployment Planning System 210 is configured, for example, in accordance with device 300 shown in FIG. 3. Device 300 may include, among other things, one or more of the following components: a central processing unit (CPU) 310 configured to execute computer program code to perform at least specific processes and methods of the embodiments herein described; memory 320, such as RAM, EEPROM, and flash memory, to store data and computer program code; an input device 330 configured to receive user input, such as a keyboard, mouse, touchscreen, microphone, or camera; an output device 340 configured to provide user output, such as a display (e.g., a touchscreen display) or speaker; and a communications device 350 configured to enable data communication with other components, such as a cellular transceiver, WLAN transceiver, and network interface controller (NIC).

In some embodiments, each WLAN System 230 controls, directly or indirectly, one or more WLAN transceivers 120 and/or one or more other networks, such as one or more small cell network transceivers 130. In addition, in some embodiments, each Cellular System 240 controls, directly or indirectly, one or more cellular transceivers 110. WLAN System 230 and/or Cellular System 240 may measure activities of User Devices 250, such as amount of traffic and speed of traffic conducted over a pre-defined time period during a day. In some embodiments, WLAN System 230 and Cellular System 240 may communicate with Cell Traffic Monitoring System 220 and provide user activity data to Cell Traffic Monitoring System 220. WLAN System 230 and Cellular System 240 may also communicate with Small Cells Deployment Planning System 210 for potential deployment of small cells.

In some embodiments, User Devices 250 comprise hardware and/or computer program code for connecting to cellular transceivers 110, WLAN transceivers 120, and/or other networks, such as small cell network transceivers 130. In some embodiments, User Devices 250 are associated with one or more WLAN Systems 230 and/or one or more Cellular Systems 240. Moreover, in some embodiments, each User Device 250 comprises a database for storing information to enable the User Device 250 to connect to particular networks, such as cellular transceivers 110, WLAN transceivers 120, and/or small cell network transceivers 130 associated with one or more WLAN Systems 230 and/or one or more Cellular Systems 240. User Devices 250 are capable of receiving data from WLAN System 230 and/or one or more Cellular Systems 240 to connect to networks. Moreover, in some embodiments, User Devices 250 are capable of transmitting data regarding the network speed and/or other quality data experienced when connected to one or more networks.

In some embodiments, Cell Traffic Monitoring System 220 collects user activity data from WLAN System 230 and/or Cellular System 240, and provides the data to Small Cells Deployment Planning System 210. For example, the data provided by Cell Traffic Monitoring System 220 to Small Cells Deployment Planning System 210 may include amount of cell traffic and speed of cell traffic, which may be used by Small Cells Deployment Planning System 210 to identify locations for future small cells deployment. In some embodiments, Cell Traffic Monitoring System 220 may analyze the collected user activity data from WLAN System 230 and/or Cellular System 240 and identify areas that may need additional deployment of small cells, and provide the user activity data of these areas to Small Cells Deployment Planning System 210. For example, Cell Traffic Monitoring System 220 may identify areas of interest where services are slow and provide the user activity data of these areas to Small Cells Deployment Planning System 210.

As depicted in FIG. 2, in some embodiments Small Cells Deployment Planning System 210 and Cell Traffic Monitoring System 220 are each employed as a separate system. However, in other embodiments, the functionality of Small Cells Deployment Planning System 210 and Cell Traffic Monitoring System 220, may be employed together in a single system.

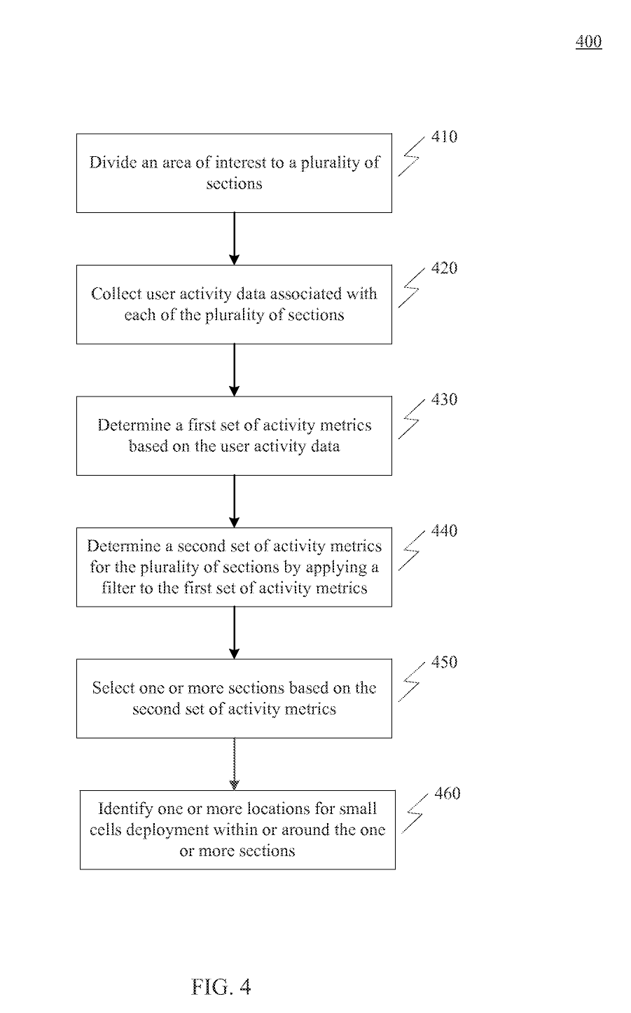

FIG. 4 depicts an example method 400 for planning small cells deployment, in accordance with some of the disclosed embodiments. In some embodiments method 400 may be implemented as one or more computer programs executed by a processor. Moreover, in some embodiments, method 400 may be implemented by any device or system, such as Small Cells Deployment Planning System 210, Cell Traffic Monitoring System 220, or any combination thereof.

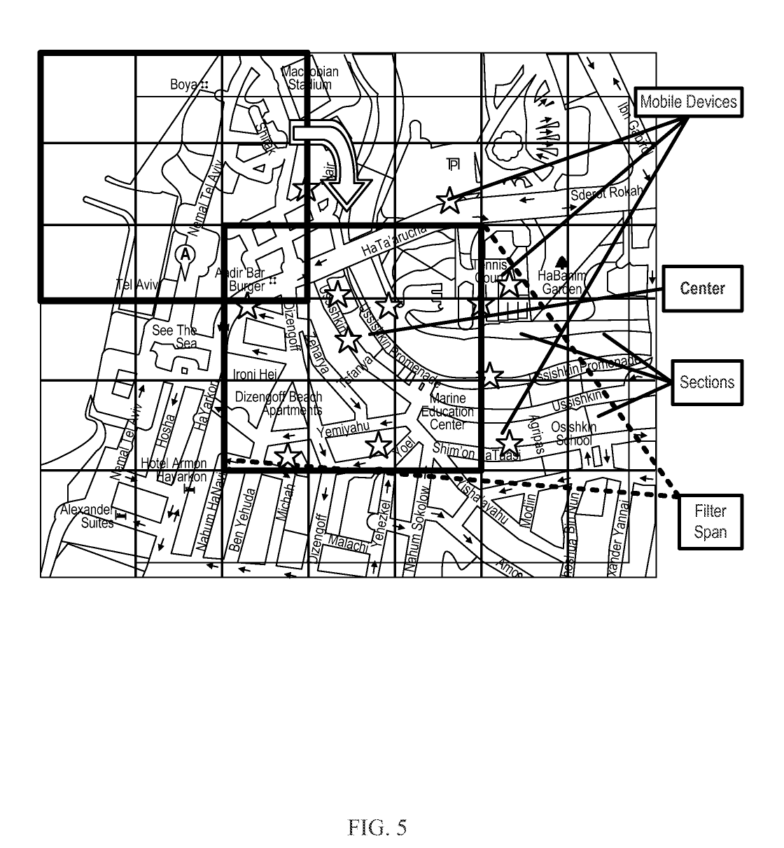

Method 400 begins by dividing an area of interest to a plurality of sections (step 410). An area of interest may include regions where heavy cell traffic causes the service to slow down. Each of the sections may be of a substantially same size. The size of the sections may be determined by a desirable wireless activity map resolution. For example, when a high resolution of wireless activity map is desired, the size of the sections may be small. On the other hand, the size of the sections may be larger if high resolution is not required in a wireless activity map. The area of interest may be divided into equal size sections in rectangular shape, hexagonal shape, or the like. An example map of an area of interest being divided into a number of sections is depicted in FIG. 5. As depicted in FIG. 5, the geographical area may be divided into a number of pre-defined sections (e.g., squares of a size between 10×10 meters and 100×100 meters). It should be understood that step 410 may be performed independently from other steps in method 400.

Method 400 also includes collecting user activity data associated with each of the plurality of sections (step 420). In some embodiments, user activity data may be collected over a pre-defined time period during a day, and may span multiple days and weeks when necessary. For example, data that is collected during noon hours may better characterize user activities in public places. In another example, data collected at night hours may better characterize user activity in residential areas. In another example, data collected over weekends may better characterize activity in recreation, entertainment centers, etc. Thus, different pre-defined time period for collecting user activity data may be set in different areas for purposes of better characterizing user activity.

User activity data may include amount of cell traffic and speed of cell traffic in each section during the pre-defined time period. In some embodiments, user activity data may include, based on the user activity, an aggregate of all network traffic for all user devices within each section during a pre-defined time period. User activity data may also include an aggregate of traffic speed for all user devices within each section during the pre-defined time period.

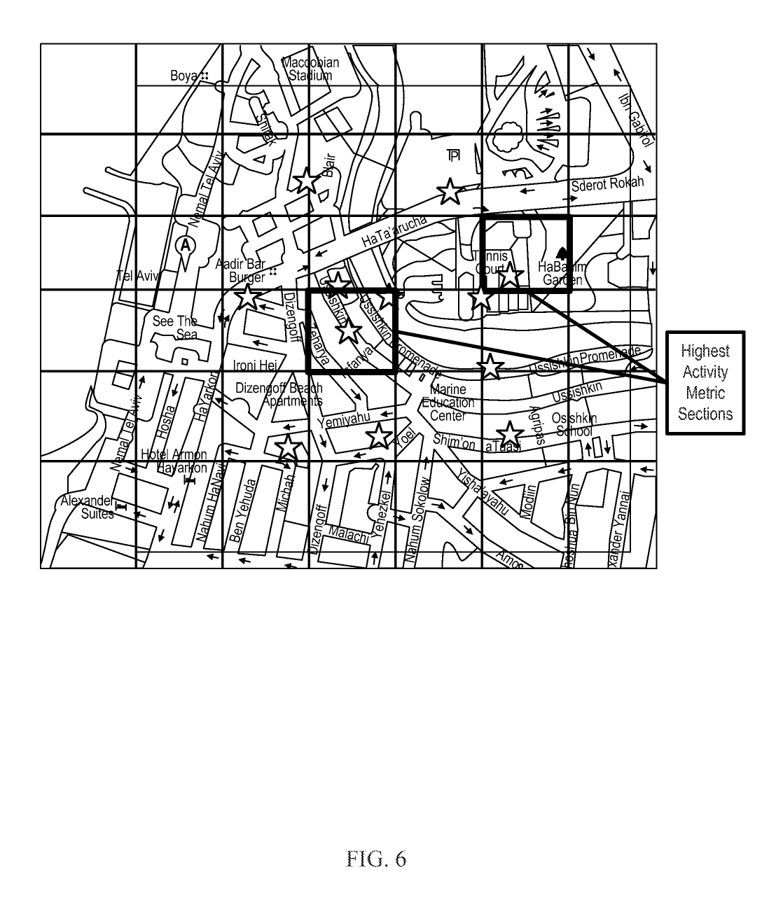

Method 400 also includes determining a first set of activity metrics based on the user activity data (step 430). The first set of activity metrics includes an activity metric for each of the sections. In some embodiments, the activity metric may be defined as a ratio between the cell traffic density and the cell traffic speed. The activity metric becomes higher as cell traffic density increases and cell traffic speed decreases. Generally speaking, sections with high activity metrics may be good candidates for small cells deployment. The activity metric Q in section i may be defined as follows:

$${Q}_{i} = \frac{{\sum }_{j} Cell\_Data \_for \_device \_at {\_section}_{ji}}{{\sum }_{j} Cell\_Data \_Speed \_for \_device \_at {\_section}_{ji}}$$

where i is index of the section (e.g., one of the map squares depicted in FIGS. 5 and 6), j is the index of devices in the section, Cell_Data_for_device_at_sectionⱼᵢ represents the amount of cell traffic for user device j at section i, and Cell_Data_Speed_for_device_at_sectionⱼᵢ represents the speed of cell traffic for user device j at section i. It can be seen that activity metric Qᵢ is determined based on the aggregated amount of traffic generated for all devices in section i and their associated data speed. Activity metric Qᵢ increases when the aggregated amount of cell traffic in section i increases and when the aggregated data speed in section i decreases. As previously described, the aggregated amount of cell traffic and speed of cell traffic may be measured during a pre-defined time period and may span a number of days or weeks for gathering of sufficient data.

Method 400 also includes applying a filter to the first set of activity metrics and obtaining a second set of activity metrics for each of sections (step 440). The second set of activity metrics includes a second activity metric for each of the sections. In some embodiments, the filter may be a two-dimensional smoothing filter, such as a Hamming filter. In some embodiments, the second activity metric Q′ in section i may be calculated as follows:

$${Q}_{i}^{′} <= {Q}_{i} + {\sum }_{k , k \neq i} {a}_{k} \cdot {Q}_{k}$$

where Q′ᵢ represents the filtered activity metric at section i (i.e., the second activity metric at section i), Qᵢ represents the unfiltered activity metric at section i (i.e., the first activity metric at section Qₖ represents the unfiltered activity metric at neighboring section k (i.e., the first activity metric at neighboring section k), and aₖ represents filter coefficient of section k. It can be seen that the filtered activity metric at section i is based on the unfiltered activity metric at the same section as well as the unfiltered activity metrics at the neighboring sections. The neighboring sections for applying the smoothing filter may include immediate neighbors to section i, or non-immediate neighbors to section i. The above described process for calculating filtered activity metric is performed for each section in the area of interest.

An example map for constructing a smoothing filter is depicted in FIG. 5. As depicted in FIG. 5, the 3×3 two-dimensional smoothing filter spans three sections in the horizontal axis and three sections in the vertical axis. It can be see that in this example, for a center section i, its immediate neighbors are taken into account for calculating the filtered activity metric. It should be understood, however, that a filter with different spans from this example may be implemented without departing from the spirit of the present disclosure.

In some embodiments, the span of the filter is determined such that it is approximately equal to the typical correlation length of the map morphology and demography. In some embodiments, the coefficient aₖ may be set depending on the distance between section k and the center section i. The value of aₖ may be set smaller as section k is farther from the center section i. For example, aₖ may be set to be a value of ⅔ for sections that are immediate neighbors to the center section i, and aₖ may be set to be a value of ⅓ for sections that are separated from the center section i by a single section. In the 3×3 filter depicted in FIG. 5, aₖ may be set to be a value of ½ as only the immediate neighbors are taken into account. It should be understood, however, that different filter coefficients may be implemented without departing from the spirit of the present disclosure.

In some embodiments, a two-dimensional polynomial interpolation may be applied to the filtered activity metrics to increase the location precision. For example, each of the sections may be further divided into a number of grids, and an interpolation of the second set of activity metrics (i.e., the filtered activity metrics) is used to obtain activity metrics of each grid within each of the sections. In doing so, the location precision for the obtained activity metrics is increased, and in turn, the location precision for the potential placement of small cells may be increased.

Method 400 also includes selecting one or more sections based on the second set of activity metrics, i.e., the filtered activity metrics, for each of the sections (step 450). In some embodiments, one or more sections with the highest activity metrics may be selected small cells deployment. An example map for selection of small cells deployment sections is depicted in FIG. 6. As depicted in FIG. 6, two sections with the highest activity metrics are selected for small cell deployments. That is, small cells may be deployed within or around the two selected sections to enhance wireless network services.

The number of sections selected for small cell deployments may be pre-determined for an area of interest. In some embodiments, sections with activity metrics that are higher than a pre-determined threshold may be selected for small cells deployments. If interpolations are used to obtain activity metrics of grids within the sections, one or more grids with the highest activity metrics may be selected for small cells deployments.

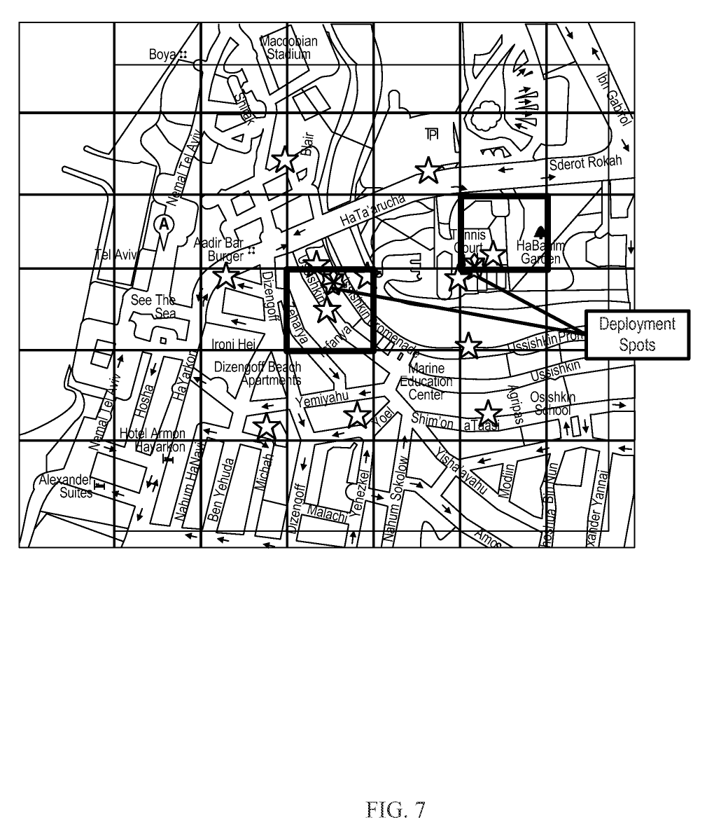

Method 400 also includes identifying one or more locations for small cells deployment within or around the selected sections (step 460). In some embodiments, the morphology and demography maps are used to identify high activity places within or around each of the selected sections, such as schools, coffee places, hotels, etc. If high activity places are found, small cells may be deployed within the identified place or nearby. An example map for identifying small cells deployment locations is depicted in FIG. 7. As depicted in FIG. 7, two small cell deployment spots are identified within or near the two selected sections. The identified small cell deployment spots are high activity places located within or around the selected sections.

In some embodiments, web search queries may be used to identify potential businesses and other public places within or around the selected sections with high activity metrics. Theses web queries may be available from various location-based services, such as Yahoo, Yelp, Foursquare, etc. An example of web search queries using Yahoo is provided below in Table 1, another example of web search queries using Google is provided below in Table 2, and another example of web search queries using Yelp is provided below in Table 3. It should be understood that other location-based services may be used to identify high activity places for small cells deployment without departing from the spirit of the present disclosure.

TABLE 1
Example Web Search Queries Using Yahoo

```
  http://local.yahooapis.com/LocalSearchService/V3/localSearch?%params
  a. params = urllib.urlencode({‘query’: term,
```

‘results’: num_biz_requested,
‘location’: address_location,
‘radius’: radius,
‘appid’:appid,
‘output’:out_method})

b. params = urllib.urlencode({‘query’: term,

‘results’: num_biz_requested,
‘latitude’: lat,
‘longitude’:longt,
‘radius’: radius,
‘appid’:appid,
‘output’:out_method})

num_biz_requested=‘10’
radius=‘10’
appid=‘Al0FGzvV34HigtWh_ZejHDuECsqmFYrlJp0mluYy9So3Ofk_Rv5B1Yw0TbMD.UR3_{—}
viEMUw-’
out_method=‘json’

TABLE 2
Example Web Search Queries Using Google

http://www.google.com/base/feeds/snippets?%params

a. params = urllib.urlencode({‘q’: term,

‘max-results’: num_biz_requested,
‘bq’: ‘[location: @“‘+address_location+’” + ‘ + radius + ’mi]’,
‘alt’:out_method})

b. params = urllib.urlencode({‘q’: term,

‘max-results’: num_biz_requested,
‘bq’: ‘[location: @‘+lat_sign+lat+longt_sign+longt+’ + ‘ +
radius + ’mi]’,
‘alt’:out_method})

num_biz_requested=‘10’
radius=‘10’
out_method=‘json’

TABLE 3
Example Web Search Queries Using Yelp

http://api.yelp.com/business review search?%params

a. params = urllib.urlencode({‘term’: term,

‘num_biz_requested’: num_biz_requested,
‘location’: address_location,
‘cc’: cc,
‘radius’: radius,
‘ywsid’:ywsid})

b. params = urllib.urlencode({‘term’: term,

‘num_biz_requested’:num_biz_requested,
‘lat’: lat,
‘long’:longt,
‘cc’: cc,
‘radius’: radius,
‘ywsid’:ywsid})

num_biz_requested=‘10’
cc=‘US’
radius = ‘10’
ywsid=‘3DFSc0hPGyDqhg4QkkWzEg’

Google Base API input and output can be found at the following web link: http://code.google.com/intl/iw-IL/apis/base/docs/2.0/attrs-queries.html. Examples of fields stored for Google Base API results are listed in Table 4. Yelp API input and output can be found at the following web link: http://www.yelp.com/developers/documentation/search_api. Examples of fields stored for Yelp results are listed in Table 5. Yahoo API input and output can be found at the following web link: http://developer.yahoo.com/search/local/V3/localSearch.html. Examples of fields stored for Yahoo results are listed in Table 6.

TABLE 4
Examples of fields stored for Google Base API results

| | |
|---|---|
| 1. | Title |
| 2. | location |
| 3. | country |
| 4. | lat |
| 5. | longt |
| 6. | Content |
| 7. | Category, type |
| 8. | phone |
| 9. | author |
| 10. | Updated |
| 11. | review type |
| 12. | link |

TABLE 5
Examples of fields stored for Yelp results

| | |
|---|---|
| 1. | name |
| 2. | Address1, address2, address3 |
| 3. | Neighborhood Name |
| 4. | City |
| 5. | state |
| 6. | state_code |
| 7. | country |
| 8. | country_code |
| 9. | zip |
| 10. | Lat |
| 11. | Longt |
| 12. | Distance |
| 13. | Is_closed |
| 14. | Category1, Category2, Category3, Category4, Category5 |
| 15. | Review_count |
| 16. | avg_rating |
| 17. | Phone |
| 18. | url |

TABLE 6
Examples of fields stored for Yahoo results

| | |
|---|---|
| 1. | Title |
| 2. | Address |
| 3. | city |
| 4. | State |
| 5. | Lat |
| 6. | Longt |
| 7. | distance |
| 8. | Category1, Category2, Category3, Category4, Category5, |
| 9. | totalReviews |
| 10. | TotalRating |
| 11. | LastReviewDate |
| 12. | url |
| 13. | BusinessUrl |
| 14. | phone |

In some embodiments, the locations for small cells deployment may be identified based on the detection of the WiFi access points by user devices. For example, in each section, the number of times and duration where a device detects and reports a WiFi access point (AP) may be counted. The access point can be open or secured. The reporting data associated with each WiFi access point may be collected. It is then determined which WiFi access points are reported most frequently. The locations of these WiFi access points may be used to determine the location for additional small cells deployment. The small cell may be a cellular cell or a WiFi access point.

In some embodiments, the user devices may transmit information of user activity data to the small cell deployment planning system in the form of wireless signals, which may be encoded, encrypted for security and compressed. The small cell deployment planning system may decode, unencrypt and/or decompress the received wireless signal to determine information associated with the user activity data. For example, the small cell deployment planning system may include a special machine or computer to execute the functionalities of decoding, decryption, and/or decompression corresponding to the wireless signals and other data processing associated with the wireless signals.

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, data processing apparatus.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification (e.g., FIG. 4) can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

What is claimed is:

1. A method for small cells deployment, comprising:
collecting user activity data associated with each of a plurality of sections within an area of interest;
determining a first set of activity metrics based on the user activity data, the first set of activity metrics including a first activity metric associated with each of the plurality of sections;
determining a second set of activity metrics for the plurality of sections by applying a filter to the first set of activity metrics, the second set of activity metrics including a second activity metric associated with each of the plurality of sections;
selecting one or more sections based on the second set of activity metrics; and
identifying one or more locations for small cells deployment within or around the one or more sections.

2. The method of claim 1, further comprising:
interpolating the second set of activity metrics using a two-dimensional polynomial interpolator; and
selecting one or more grids within the plurality of sections based on the interpolated activity metrics.

3. The method of claim 1, wherein the first set of activity metrics is determined based on an amount of cell traffic and a cell traffic speed associated with each of the plurality of sections.

4. The method of claim 1, wherein the user activity data is collected over a pre-defined time period of a day for a number of days.

5. The method of claim 1, wherein the filter is a two-dimensional smoothing filter.

6. The method of claim 1, wherein coefficients of the filter are determined based at least in part on a correlation length of a map morphology and demography associated with the area of interest.

7. The method of claim 1, wherein the one or more sections have the highest values of the second activity metrics among the second set of activity metrics.

8. The method of claim 1, wherein identifying the one or more locations includes identifying high activity places within or around the one or more sections.

9. The method of claim 1, wherein identifying the one or more locations is based on web search queries using one or more location-based web services.

10. The method of claim 1, wherein each of the plurality of sections has a substantially same size.

11. The method of claim 1, further comprising dividing the area of interest to the plurality of sections.

12. A small cells deployment system, comprising:
at least one processor;
at least one memory device comprising instructions which, when executed by the at least one processor, cause the small cells deployment system to perform operations including:
collecting user activity data associated with each of a plurality of sections within an area of interest;
determining a first set of activity metrics based on the user activity data, the first set of activity metrics including a first activity metric associated with each of the plurality of sections;
determining a second set of activity metrics for the plurality of sections by applying a filter to the first set of activity metrics, the second set of activity metrics including a second activity metric associated with each of the plurality of sections;
selecting one or more sections based on the second set of activity metrics; and
identifying one or more locations for small cells deployment within or around the one or more sections.

13. The small cells deployment system of claim 12, wherein the instructions, when executed by the at least one processor, further cause the small cells deployment system to perform operations including:
interpolating the second set of activity metrics using a two-dimensional polynomial interpolator; and
selecting one or more grids within the plurality of sections based on the interpolated activity metrics.

14. The small cells deployment system of claim 12, wherein the first set of activity metrics is determined based on an amount of cell traffic and a cell traffic speed associated with each of the plurality of sections.

15. The small cells deployment system of claim 12, wherein the user activity data is collected over a pre-defined time period of a day for a number of days.

16. The small cells deployment system of claim 12, wherein the filter is a two-dimensional smoothing filter.

17. The small cells deployment system of claim 12, wherein coefficients of the filter are determined based at least in part on a correlation length of a map morphology and demography associated with the area of interest.

18. The small cells deployment system of claim 12, wherein the one or more sections have the highest values of the second activity metrics among the second set of activity metrics.

19. The small cells deployment system of claim 12, wherein identifying the one or more locations includes identifying high activity places within or around the one or more sections.

20. The small cells deployment system of claim 12, wherein identifying the one or more locations is based on web search queries using one or more location-based web services.

21. The small cells deployment system of claim 12, wherein each of the plurality of sections has a substantially same size.

22. The small cells deployment system of claim 12, wherein the instructions, when executed by the at least one processor, further cause the small cells deployment planning system to perform operations including dividing the area of interest to the plurality of sections.

23. A non-transitory computer-readable medium comprising instructions for an electronic device, the instructions being executable by a processor of the electronic device for causing the electronic device to perform operations including:
collecting user activity data associated with each of a plurality of sections within an area of interest;
determining a first set of activity metrics based on the user activity data, the first set of activity metrics including a first activity metric associated with each of the plurality of sections;
determining a second set of activity metrics for the plurality of sections by applying a filter to the first set of activity metrics, the second set of activity metrics including a second activity metric associated with each of the plurality of sections;
selecting one or more sections based on the second set of activity metrics; and
identifying one or more locations for small cells deployment within or around the one or more sections.

24. A network, comprising:
a plurality of small cells; and
a plurality of user devices,
wherein
(i) user activity data associated with each of a plurality of sections within an area of interest is collected,
(ii) a first set of activity metrics based on the user activity data is determined, the first set of activity metrics including a first activity metric associated with each of the plurality of sections;
(iii) a second set of activity metrics for the plurality of sections is determined by applying a filter to the first set of activity metrics, the second set of activity metrics including a second activity metric associated with each of the plurality of sections,
(iv) one or more sections is selected based on the second set of activity metrics, and
(v) one or more locations is identified for small cells deployment within or around the one or more sections.
